(19) United States
(12) Patent Application Publication
(10) Pub. No.: US 2007/0122911 A1
(43) Pub. Date: May 31, 2007

(54) Systems, Methods and Computer Program Products for Preparing, Documenting and Reporting Chemical Process Hazard Analyses

(75) Inventors: Christine E. Browning, Kingsport, TN (US); Peter N. Lodal, Kingsport, TN (US); Tee B. Tolbert, Kingsport, TN (US)

Correspondence Address: Sorojini J. Biswas;Myers Bigel Sibley & Sajovec, Post Office Box 37428, Raleigh, NC, 27627, US

(73) Assignee: Eastman Chemical Company

(21) Appl. No.: 11/549,838

(22) Filed: Oct. 16, 2006

Related U.S. Application Data
(63) Continuation of application No. 09/670,214, filed on Sep. 25, 2000, now abandoned.
(60) Provisional application No. 60/155,729, filed on Sep. 23, 1999.

(51) Int. Cl. G01N 35/08

(52) U.S. Cl. 436/55

(57) ABSTRACT

A process hazard analysis (PHA) is performed in a data processing system. A chemical process to be evaluated is selected, after which a study type to be performed on the chemical process is also selected. The study type is conducted to evaluate the chemical process for the presence of hazard scenarios and any associated deficiencies requiring recommendations. After conducting the study, resolution plans to address the recommendations are generated. The study type used in the analysis may be customized or may be a known study type. The study type may use a risk matrix to generate a risk ranking for the hazard scenario. The risk matrix used may be created by the user, or may be a known risk matrix from another study type. After a resolution plan is generated, a resolution database may also be generated.

### RELATED APPLICATIONS

This application is a continuation of application Ser. No. 09/670,214, filed Sep. 25, 2000, entitled Systems, Methods and Computer Program Products for Preparing, Documenting and Reporting Chemical Process Hazard Analyses, and claims the benefit of U.S. Provisional Application No. 60/155,729, filed Sep. 23, 1999, both of which are incorporated herein by reference in their entirety.

### FIELD OF THE INVENTIONS

This invention relates to computer-integrated chemical process hazard analysis systems, methods and computer program products.

### BACKGROUND OF THE INVENTION

The manufacture of chemical products is becoming increasingly complicated as worldwide demand for chemical products, and the complexity of the products, continue to increase. Modern chemical plants are generally sprawling complexes that employ hundreds, if not thousands of employees to manufacture many diverse chemicals. Due to the toxic and/or flammable nature of certain chemicals, the chemical industry is highly regulated by many national and local laws. For example, in the United States, chemical manufacturers are required by the Occupational Safety and Health Administration (OSHA) to comply with a standard known as Process Safety Management (PSM) for the management of highly hazardous chemicals (29 C.F.R. 1910.119, hereinafter “OSHA § 1910.119”). Moreover, as part of the Clean Air Act Amendment (40 C.F.R. Part 68, §112(r)(7) “Accidental Release Prevention Requirements: Risk Management Programs Under Clean Air Act Section”), and as overseen by the Environmental Protection Agency (EPA) chemical manufacturers must also file a Risk Management Plan (the EPA RMP) that includes an analysis of the potential offsite consequences of an accidental chemical release, a five-year accident history, a release prevention program, and an emergency response program. Failure to comply with governmental regulations can result in severe penalties for a chemical manufacturer. Unfortunately, compliance with OSHA § 1910.119 and other regulations is becoming increasingly complicated due to the increasing number and complexity of chemical products that are being produced, and the increasing number and complexity of regulations that govern the manufactured products.

In order to comply with governmental regulations, many chemical manufacturers implement some form of process safety program. These process safety programs are generally programs or activities that involve the application of management principles and analytical techniques to ensure process safety in chemical facilities, with a focus on preventing major accidents. Process Hazard Analysis (PHA) is generally defined as an organized effort to identify and evaluate hazards associated with chemical processes and operations to enable their control. This review normally involves the use of qualitative techniques to identify and assess the significance of chemical hazards, from which action plans and appropriate recommendations are developed. Occasionally, quantitative methods are used to help prioritize and analyze risk reduction. A summary of techniques for performing PHAs can be found in “Guidelines for Hazard Evaluation Techniques, Second Edition with Worked Examples,” (Center for Chemical Process Safety of the American Institute of Chemical Engineers, New York (N.Y.) (1992)). This reference is specifically cited in OSHA literature as a source for process hazard analysis techniques that facilitate compliance with 29 C.F.R. 1910.119.

Under OSHA regulations, there are six methodologies that may be used for process hazard analysis. The methodologies range from highly qualitative to highly quantitative. One example of a PHA technique that has traditionally been used in many chemical companies is known as the Hazard and Operability Analysis, or “HAZOP.” HAZOP is a rigorous, highly structured PHA methodology designed to evaluate the potential hazard and operability problems of highly complex chemical processes and segments or steps thereof. Unfortunately, HAZOP is generally not computer-based. As such, HAZOP analyses may need to be manually performed. HAZOP and other standard PHA techniques also generally require lengthy studies that must be performed by highly trained users. Documentation of analyses performed using HAZOP and related techniques is generally poor and difficult to follow. Additionally, these techniques may not provide formal systems for conducting process studies, reporting the studies, or providing recommendations for follow-up guidelines if and when deficiencies in chemical processes are found.

In light of the increasing complexities of chemical production and the difficulties associated with traditional PHA techniques, a need exists for methods and systems that are capable of systematically performing up to several hundred process hazard analyses and identifying potential physical and chemical hazards, including what the parameters and consequences of the hazards are, the likelihood of damage caused by such hazards, and recommendations directed to the prevention of these hazards and consequences. To this end, computer systems and methods have been implemented for analyzing and documenting the hazards that are associated with chemical processing and manufacturing. For example, recognizing that different processes and nodes thereof are more suited to particular methodologies, in 1993 the Eastman Chemical Company created a computer-based system known as Process Hazard Analysis & Risk Assessment (PHARA). PHARA was able to apply multiple methodologies per process or node.

In light of the foregoing, a need still remains for a formal and reliable system that will allow chemical manufacturers to meet governmental regulations, such as OSHA 1910.119(e), and to document and track numerous and complex PHAs.

### SUMMARY OF THE INVENTION

The present invention includes systems, methods, and computer products for conducting Process Hazard Analyses (PHAs) in compliance with OSHA 29 CFR 1910.119. Moreover, the invention can allow for conducting and documenting safety analyses or process studies not necessarily specified by OSHA, thus allowing chemical manufacturers to comply with, for example, regulations outside the United States.

In order to conduct PHAs according to the present invention, hazard scenarios (either real or hypothetical) are developed for chemical processes based on deviations from normal operations or failures of process components (i.e., equipment, instruments, etc.). An evaluation of the risk ranking of each particular hazard scenario is performed, and the need for corrective action (hereinafter referred to as “recommendations”) to bring the risk ranking to an acceptable level is determined. The result of a PHA conducted according to the present invention can be both the documentation of chemical process hazards and the generation of recommendations for ameliorating these hazards. After recommendations have been determined by users of the invention, chemical manufacturers may then address and resolve these hazards in a timely manner through resolution plans and action items that may also be generated through the use of the present invention.

An initial step for conducting a PHA according to the present invention is preferably the selection of a chemical process to be evaluated. In the “Preplanning Studies” component or phase of the present invention, appropriate study type(s), as defined herein, are chosen for this evaluation. Exemplary study types include OSHA specified PHA study types if the process to be evaluated is required to be in compliance with the Process Safety Management (PSM) standard. Alternatively, the study type may be a general process safety review if the process is not covered by the PSM standard, or may even be a Maintenance and Operability (MOP) study. If desired, the user(s) of the invention (generally, a PHA expert or a team of process, PHA, and safety experts) may also create their own study type, or customize an existing study type for their own particular needs. Based on available process information such as Piping & Instrumentation Diagrams (PID's), known chemical procedures, chemical hazard information and the like, the process to be evaluated then may be broken into sub-processes or segments called “nodes,” as defined further herein.

For each node to be analyzed according to the present invention, appropriate questions or queries for evaluating the node are selected, based on (for example) the equipment in the node, the processing steps involved, and the chemical or physical hazards involved. Additional information about the node and/or process may be gathered and documented for the study, such as previous significant incidents, chemical facility site information, and general process or facility safeguards.

After the “Preplanning Studies” component of the invention is completed, the “Conduct Study” phase or component of the invention then may be carried out. This phase can allow the user of the invention to evaluate the selected process or node, identify any potential hazard scenarios, and determine any needed recommendations. Generally, certain questions are asked with respect to each node. For each question, the user can determine whether one or more hazard scenarios exist, and whether or not the scenario is significant enough to be documented.

For example, typically for each question asked (or deviation posed) the scenario documented is the one that represents the “Worst Case Credible Consequence,” as defined further herein. Additional scenarios might involve situations in which only some (rather than all or most) safety controls fail leading to a consequence of less severity as compared to the Worst Case Credible Consequence. However, this other scenario may be more likely to occur as compared to the Worst Case Credible Consequence, and may therefore be determined by the user to be worthy of documentation. At the completion of the study, the user(s) will determine the Worst Case Credible Consequence for the entire process and document it in the report.

Once a scenario is documented, the user may qualitatively evaluate the severity of the expected consequence of that scenario. The user may then identify the controls that exist that may prevent or mitigate the scenario. When taking into consideration the number, type, and reliability of the controls identified, the user may subjectively determine a frequency at which the scenario resulting in the documented consequence is expected to happen. Based on the scenario's consequence and frequency, a risk ranking or priority is assigned by the present invention, based on the risk ranking matrix associated with the study type chosen for the evaluation, as defined herein. The user can then determine if controls are adequate. If the controls are deemed inadequate, a recommendation for a resolution to the hazard or scenario is made. After the foregoing steps are performed for all questions pertaining to all nodes of the selected process, the PHA may be considered complete.

However, the present invention further and advantageously can allow the users of the invention to determine and track resolutions for the recommendations made during the “Conduct Study” phase of the invention. During the “Resolution” phase or component of the present invention, a user(s) of the invention can review the recommendations generated in the previous phase, and develop a resolution plan for the study that was conducted on the process. In general, a resolution plan may be required by governmental regulation to be developed and implemented in a timely manner, and will include one or more resolution/action items per recommendation. For example, OSHA regulations specify that action items should be completed as soon as possible. The user may use the invention to develop target dates for the completion of the resolution, based on the scenario's risk ranking and/or the magnitude of effort needed to implement the action item. In some cases, depending upon the risk ranking of a scenario, a selected process actually in use by a chemical company must be shut down until the action item is completed. In this case, a very near term target date will preferably be assigned.

After the resolution plans/action items are documented, the status of these items are preferably updated on an ongoing basis by the invention. In the “Scheduling Tracking/Status” phase or component of the invention, periodic reports may be generated to indicate action items completed, action items not completed, and those action items or resolutions that are past the target date. This data can be sorted and then distributed in various ways, such as (for example) by person(s) responsible for a particular action item, person(s) responsible for resolution of the study, or by organizational sub-identity. Additionally, the invention can allow the user to periodically check the status of completion of action items against the target dates for completion of the action items, and then take the appropriate action if completion by the target date seems unlikely. For example, if there is less than a week until the target date or the target date has passed for the completion of an action item, a notice may be sent to the persons responsible for completing the items. A chemical company can thus manage resolutions to completion while facilitating compliance with the PSM standard.

According to federal regulations, PHAs generally must be revalidated (updated) every five years. For a company with many processes that must be revalidated, as well as new processes for which PHAs are required, coordinating and tracking the scheduling and statuses for these various processes may be complex and time-consuming. The present invention can advantageously provide for the creation of a report or reports that sets forth every process that is evaluated, various related studies, and their status with respect to preplanning, conducting the study, resolving recommendations, and completion. Additionally, milestone timepoints may be established to ensure that critical dates at the study level are not missed.

Should a company or site not desire to use the default PHA study type configured in the software for their safety evaluation or process study, another study type may be configured. A study type is a specific grouping of options that may be selected by the user for conducting a study. The options for configuring a study type include the risk matrix, screen behavior, particular questions to be considered for each process, types of resolution plans/action items used for classification and scheduling, control types, and timeframe constants for items such as reports, revalidations, and implementation of resolution/action items, as these terms are defined herein. Study types may also vary in relation to the number of fields or factors to be considered. For example, a particular user may not want to classify a consequence and/or frequency for each and every scenario associated with a particular hazard. Alternatively, the user may not wish to list all the safety controls applicable to a particular scenario.

Overall, the present invention can provide formal computer-integrated systems, methods and products for conducting PHAs. The systems, methods and products can have multiple computer platform compatibility; can support multiple methodologies for PHAs; can allow the users of the invention to customize multiple study variables such as risk ranking systems and resolution timelines; can provide resolution tracking and status capabilities (including a formal report generator); and can allow the users of the invention to efficiently meet the requirements of OSHA 1910.119(e) in addition to other governmental regulations.

The foregoing and other aspects of the present invention are explained in detail in the specification set forth below.

### BRIEF DESCRIPTION OF THE DRAWINGS

FIGS. 1A and 1B, which together form FIG. 1 as indicated, is a block diagram of systems, methods and computer program products for preparing, conducting, documenting and reporting chemical process hazard analyses, according to embodiments of the invention.

FIG. 2 is a flow chart illustrating an aspect of the present invention that relates to customizing process hazard analyses for particular site use.

FIG. 3 is a flow chart illustrating an aspect of the present invention that relates to creating and editing study types and options.

FIGS. 4A, 4B, and 4C, which together form FIG. 4 as indicated, are flow charts illustrating an aspect of the present invention that relates to documenting hazards during a process hazard analysis.

FIG. 5 is a flow chart illustrating an aspect of the present invention that relates to determining planned actions for recommendations as part of a process hazard analysis.

FIG. 6 is a flow chart illustrating an aspect of the present invention that relates to the tracking of resolutions and determining the status of process hazard analyses.

### DETAILED DESCRIPTION OF THE PREFERRED EMBODIMENTS

Certain objects, advantages and novel features of the invention will be set forth in the description that follows, and will become apparent to those skilled in the art upon examination of the following, or may be learned with the practice of the invention.

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, an apparatus, a data processing system or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code embodied in the medium. Any suitable computer-readable medium may be utilized including hard disks, CD-ROMs, optical storage devices, or magnetic storage devices.

In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (but a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). It will be understood that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is also described with reference to flowchart illustrations of methods, apparatus (systems) and computer program products according to the invention. It will be understood that each block of the flowchart illustrations, portions of the operations described in the flowchart illustrations, and combinations of blocks in the flowchart illustrations, can be implemented by computer program instructions. These computer program instructions may be loaded onto and executed by a general purpose computer, special purpose computer or other data processing apparatus, thus producing a machine which provides means for implementing the functions specified in the flowchart blocks and combinations thereof. The computer program may cause operational steps to be performed on the computer or data processing apparatus to produce a computer-implemented process such that the instructions which execute on the computer or data processing apparatus provide steps for implementing the functions of the flowchart blocks or combinations thereof. Accordingly, blocks of the flowchart illustrations support combinations of means for performing the specified functions and combinations of steps for performing the specified functions.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

In one embodiment, the data processing system used in the present invention may be a computer capable of running a wide range of application software and may include a central processing unit (CPU), memory, a network communications device, an internal or external hard disk drive or other kind of persistent data storage, a keyboard, a pointing device (i.e., a mouse), a display (i.e., a monitor), and other internal or external hardware and software components commonly found in computers, such as personal computers. The keyboard may have a plurality of keys thereon, and may be communicatively coupled to the CPU. The CPU contains one or more microprocessors or other computational devices and random access memory or its functional equivalent, including but not limited to, RAM, FLASHRAM, and VRAM for storing programs therein for processing by the microprocessor(s) or other computational devices.

The data processing system may be an IBM-compatible personal computer with a Pentium® microprocessor (Intel Corporation, Santa Clara, Calif. USA) or its equivalent, and preferably utilizes either a Windows®, Windows NT®, Unix®, or OS/2® operating system. The data processing system may be a stand-alone computer, or a computer or workstation connected to a network. However, it is to be understood that the present invention may be implemented using other processors and via other computing devices, including, but not limited to, mainframe computing systems, mini-computers and other data processing systems not enumerated herein. Memory, in the form of semiconductor memory (DRAM, SRAM, EEPROM, etc), magnetic memory (floppy and hard disk drives), optical memory (CD-ROM) and other forms of memory known in the art may be provided, but the particular kind of memory utilized by the computer is not critical to the operation of the present invention. A data processing system (i.e., a computer) of the present invention is preferably programmed with a computer program product that comprises computer code for preparing, conducting, documenting and reporting chemical process hazard analyses, as described further herein.

The following definitions apply herein unless otherwise specified: “Consequence” means the cumulative, undesirable result of an incident, usually measured in health/safety effects, environmental impacts, loss of property, and business interruption costs. “Consequence analysis” means the analysis of the expected effects of an incident, independent of its likelihood. A “control” is defined as any device, apparatus, or process that is meant to minimize, mitigate, prevent or warn of a potential hazard. Controls may include process controls and safety devices such as ventilation, pressure relief valves, combustible gas detectors, double-walled pipes and tanks, fire extinguishers, liquid confinement dikes, splash shields, fire walls, back flow preventors and siphon breaks, overflow vessels, chemical traps and filters, and protective cages to protect chemicals or structures from impact with moving objects. Controls may also include mitigating features of chemical systems, such as driving force controls (power and air cut-offs, pressure relief devices, emergency cooling systems), solenoid and control valves, spray/sprinkler systems, auxiliary ventilation and alarm systems. Controls may also be management or administrative procedures such as safety training for employees, routine audits, incident investigations, maintenance of sites and plants, document control, and control of purchased material, equipment and supplies.

“Documenting” a hazard, a hazard scenario, a resolution plan, a report, an action item, a failure, or any other event or data will be understood to mean that the event or data is recorded and/or stored, preferably in computer-readable media (e.g., computer readable memory) of the data processing system of the present invention. The documentation of the event or data is preferably easily accessed and retrievable from the media on which it is stored.

A “failure” is an unacceptable difference between expected and observed performance. “Hazard” means a chemical (toxicity, flammability, corrosion, stability, etc.), physical (vibration, abnormal stresses, erosion, external forces, etc.), and/or a changing condition (chemical reactions, blending operations, heating, etc.) that has the potential for causing damage to human life, property, or the environment. An “incident” is an unplanned event or series of events and circumstances that may result in an undesirable consequence.

As used herein, the term “process” is used in the same sense as defined by OSHA, wherein a process may include only the sections of a chemical operation or train where highly hazardous chemicals are present or could be released at (or above) the specified threshold quantities during a credible event (i.e., failure(s)). A “node” is a segment of a process that preferably comprises not more than one major piece of equipment (i.e., reactor, storage tank, dryer, crystallizer, etc.) and its adjoining auxiliary equipment (i.e., agitators, adjoining piping, inerting system, etc.).

A process hazard analysis, or “PHA,” is an organized effort to identify and evaluate hazards associated with chemical processes and operations to enable their control. This review generally involves the use of qualitative techniques to identify and assess the significance of hazards, in which conclusions and appropriate recommendations are developed. Occasionally, quantitative methods are used in PHAs to help prioritize risk reduction.

“Risk,” as defined herein, is a measure of economic loss or human injury in terms of both the incident likelihood and the magnitude of the injury. “Risk assessment” is the systematic evaluation of the risk associated with potential hazards at complex facilities or operations, while “risk management” is the systematic application of management policies, procedures, and practices to the tasks of analyzing, assessing, and controlling risk in order to protect employees, the general public, and the environment as well as company assets, while avoiding business interruptions. Risk management includes decisions to use suitable engineering and administrative controls for reducing risk. “Risk ranking” refers to a systematic means of assigning a priority value to each question or query associated with the evaluation of a process or node, and the corresponding potential hazards that are evaluated by a user of the present invention during a PHA. The priority value or “priority ranking” may be determined by evaluating both the potential worst case credible consequence (defined below) and the frequency (i.e. likelihood) with which the consequence may occur.

A “risk matrix” may be used to determine the risk ranking of a process or node. A risk matrix is a matrix or table that, for example, sets forth both the relative severity of a hazard (on one axis of the matrix) in relation to its potential frequency of occurrence (on another axis). In the practice of the present invention the user may customize the size of the matrix by choosing the number of entries on each axis of the matrix (i.e., may select the number of columns and rows of the table). A risk matrix can be used to provide guidelines for accepting or not accepting the analyzed frequency and consequence of the potential chemical hazard.

A “resolution plan,” as used herein, is the resolution, solution, or, colloquially, a “fix” for a deficiency discovered by a user of the invention, wherein the resolution is accomplished by the formation (designing) of a specific plan to alleviate the deficiency. A resolution plan may be a formal method of satisfying the recommendation that, reduces, prevents, and/or mitigates a hazard, or an alternate solution that lowers the risk of the hazard. Alternatively, the resolution plan may be a concrete justification as to why no further action need be taken with regard to a particular hazard.

“Master lists” refer to lists from which selections can be made when using the present invention, such as lists of controls (i.e., safety devices and systems for minimizing potential hazards), personnel, chemicals, scenarios, recommendations, corporate structure (ie., divisions, units, departments, etc.), security privilege (by role), equipment, etc.

A “study type” is a specific grouping of options that can be selected by a user of the invention for conducting a study. Study types may be known to the user, or may be created and customized by the users themselves. One study type useful in the practice of the invention is TEDPHA, a PHA study type used by the Tennessee Eastman Division in Kingsport, Tennessee. The TEDPHA study type is in compliance with the PSM standard, OSHA 29 CFR 1910.119. Another useful study type is a Maintenance and Operability (MOP) study. TEXPHA and CARPHA are still other study types that are used to conduct a PHA that meets the PSM standard, but which use slightly different options than that of TEDPHA based upon the particular conditions at the sites or plants at which these study types were developed. Yet another useful study type is the Distributed Control System (DCS) failure analysis study type.

The user may elect to customize a study type by modifying an existing study type (i.e., in order to make the study type specific for a particular site or plant), or by creating a new study type, in whole or in part. The options for customizing a study type include, but are not limited to, configuring a risk matrix, configuring the screen behavior of the question and recommendation screens displayed to the user during the conducting of the PHA, selecting the questions to be used to evaluate the chemical process or node thereof, selecting the types of resolution plans/action items used for classification and scheduling, selecting the control types to be evaluated or recommended by the study type, and selection of timeframe constants for items such as reports, revalidation, and implementation of resolution/action items.

A “study” is a work session with the same team, a defined start and end date, that addresses a single process. More than one study type can be used in a study, such as both TEDPHA and MOP.

“Screen behavior” is the functionality provided in the computer program products of the present invention on, for example, a question screen that shows all the fields that must be answered for PHA.

A “scenario” is a potential response to a deviation that is determined by the user of the invention which explains an initiating failure, chain reaction of failures, and consequence of these failures. Scenarios are referred to herein as “hazard scenarios,” although those skilled in the art will recognize that term as being interchangeable with a “deviation scenario” (generally the term for a scenario in a MOP study type).

As used herein, the term “Worst Case Credible Consequence” refers to the most serious realistic incident that can occur due to a potential deviation from safe operating parameters or an external source/event without consideration being given to existing active engineering controls (i.e., pressure relief valves, interlocks, automatic fire protection systems, etc.) and administration controls to mitigate or alleviate the potential hazard. In the determination of the Worst Case Credible Consequence, consideration is generally given to well-maintained passive general safeguards, such as space separation, special safety construction, fireproofing, etc., which are highly unlikely to fail during an emergency and in normally occupied locations where the initiation of mitigation efforts to alleviate a hazard can promptly begin.

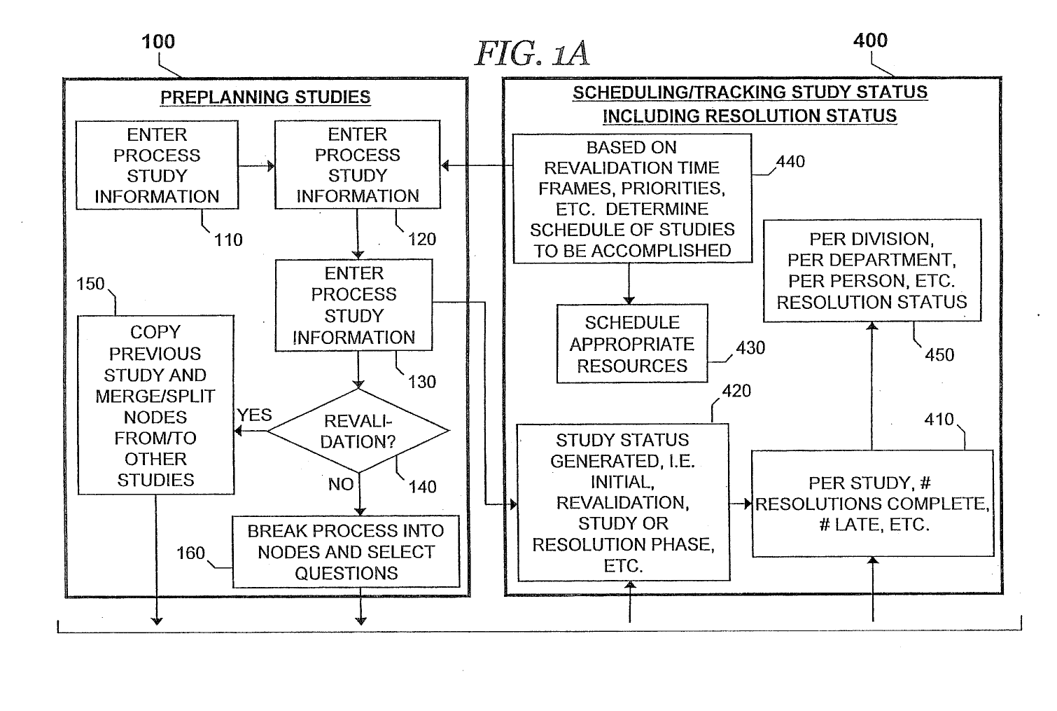

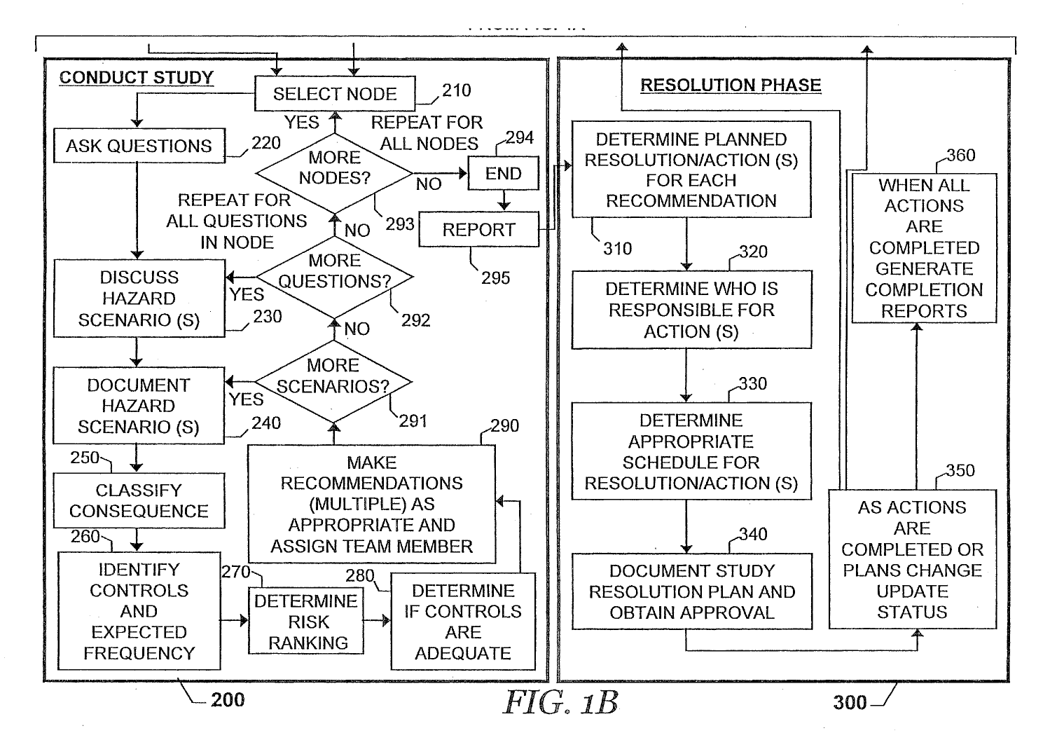

Referring now to FIG. 1, an architecture of systems, methods and computer program products for chemical process hazard analyses in accordance with embodiments of the present invention will now be described. It will be understood that systems, methods and computer program products according to the present invention are preferably implemented as a stored program that executes on a data processing system. A legacy data processing system, such as an IBM Model S/390 may be used. Alternatively, however, a midrange or a personal system and a network of legacy, midrange and personal systems may be used. As shown in FIG. 1, the present invention may comprise four major components or phases: “Preplanning Studies” (block 100); “Conduct Study” (block 200); “Resolution Phase” (block 300); and “Scheduling/Tracking Study Status (Including Resolution Status)” (block 400).

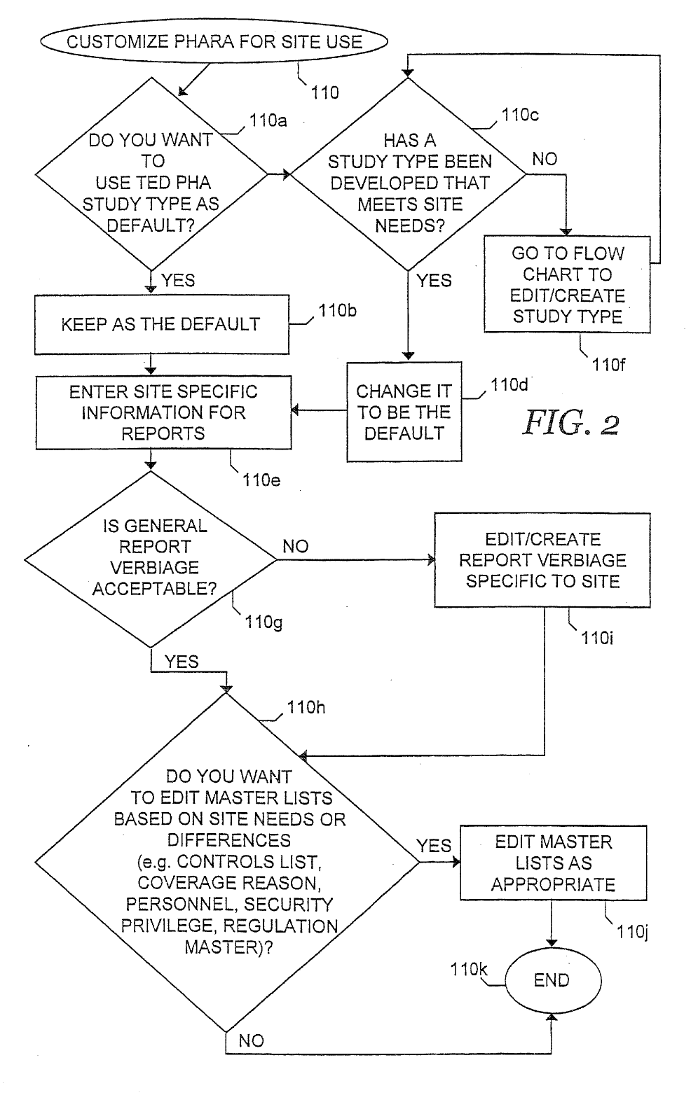

Briefly, “Preplanning Studies” (block 100) allows users of the present invention to customize the particular study that they wish to perform on the node or process. For example, users may modify parameters of the study (i.e., risk ranking, timeline for resolution, etc.), by setting up customized option matrices. In carrying out this component of the invention, a user of the invention may choose to customize software for a site (block 110), or may alternatively choose to utilize an existing study type. More specific descriptions of the customizing of the software is described herein in more detail in FIG. 2.

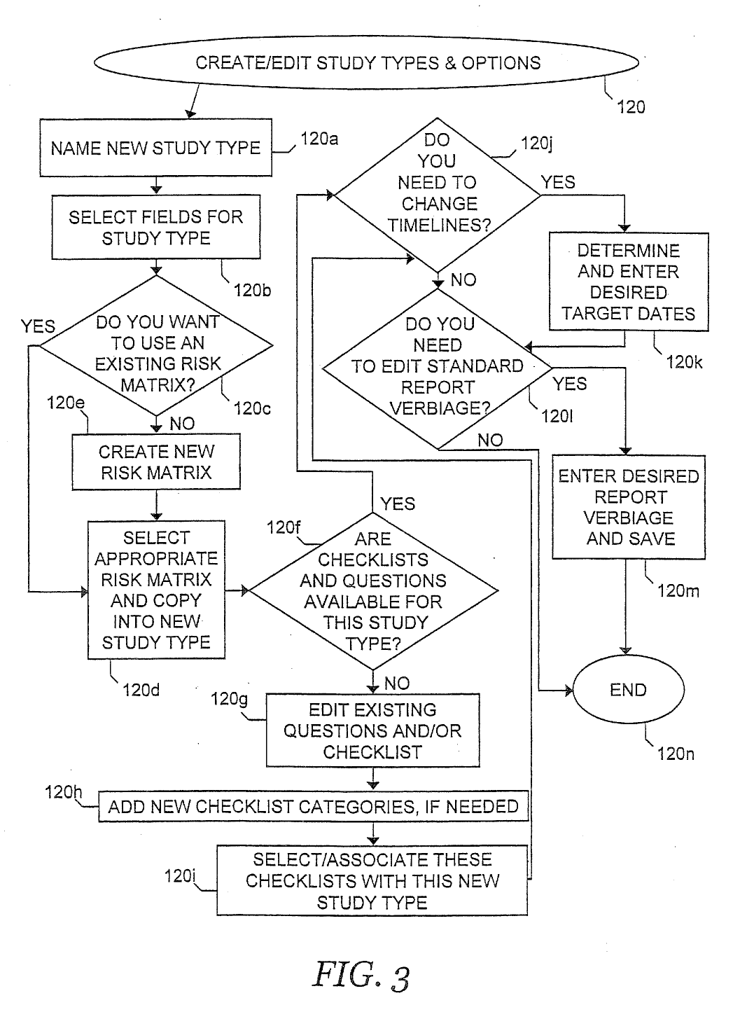

Study types, both customized or pre-planned (see FIG. 3), may be edited and the options for the study entered (block 120) prior to conducting the study. After the user determines which study type will be used, the process study information required by the study is entered (block 130). Next, a determination as to whether the study is to be a revalidation study or an initial study is made (block 140). Additionally, the process study information forms the basis of a study status which is generated (block 420), and which is updated as the analysis continues and the resolution performed, the study status being able to track data per study, the number of resolutions completed, the number of resolutions that are or are not meeting a determined timetable, and the like (block 410). Additionally, the study status is able to track how the resolution is progressing as per division, per department, per person responsible for particular tasks, and the like (block 450). If it is determined that the study performed will be a revalidation study (block 140), then the previous study is copied and then either merged with or split into nodes from other studies (block 150). If it is determined that the study is to be an initial study (i.e., not a revalidation study), then the process is broken into nodes, and questions to be used in the study are selected (block 160).

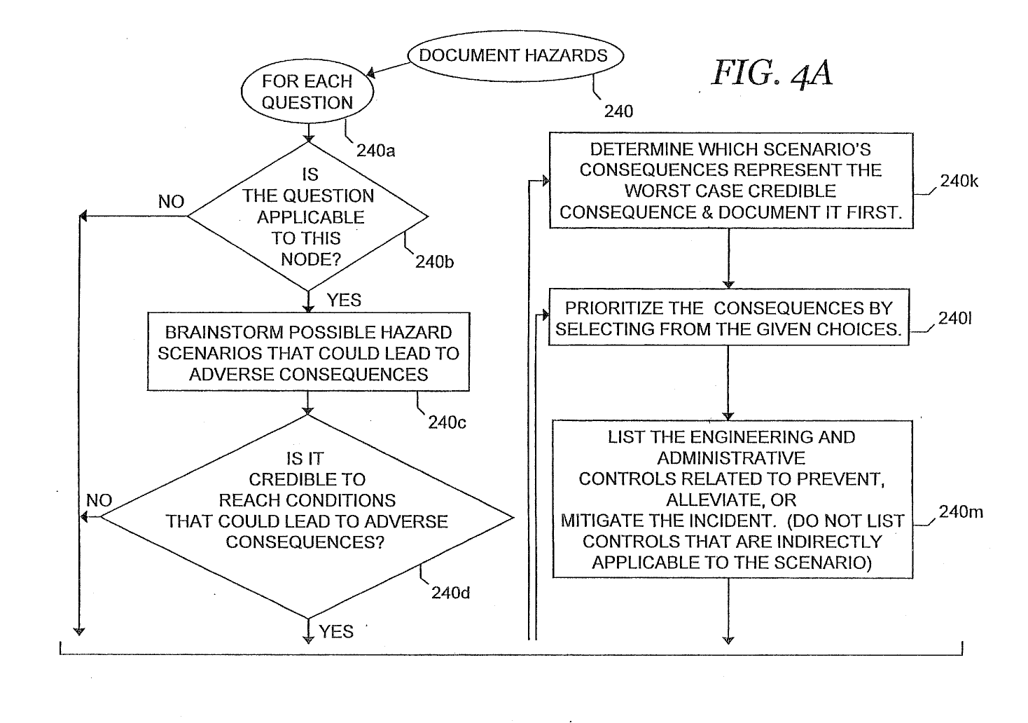

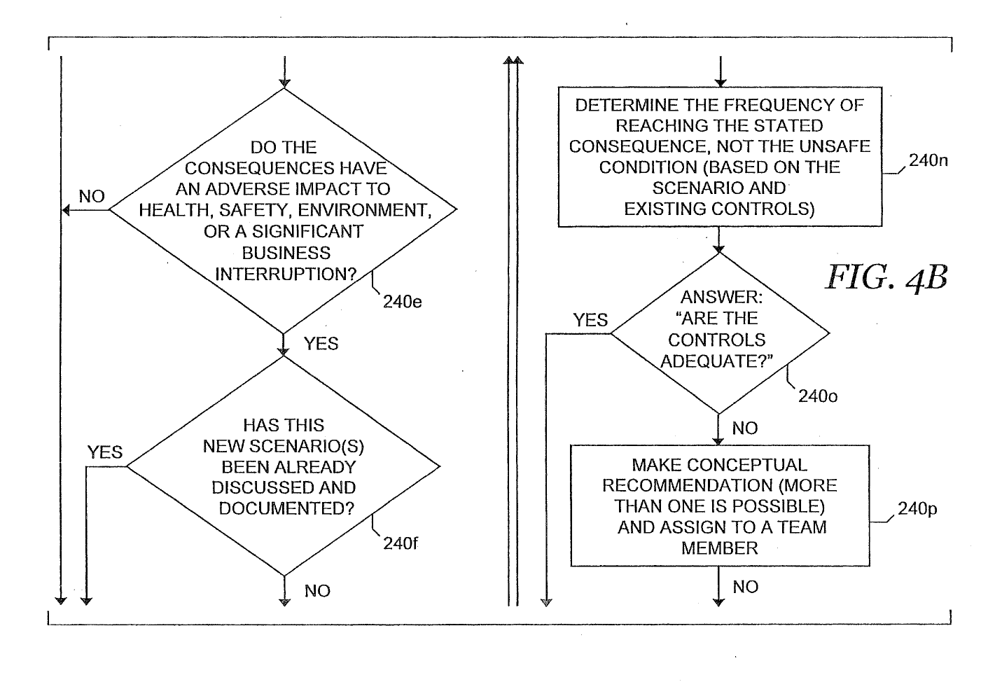

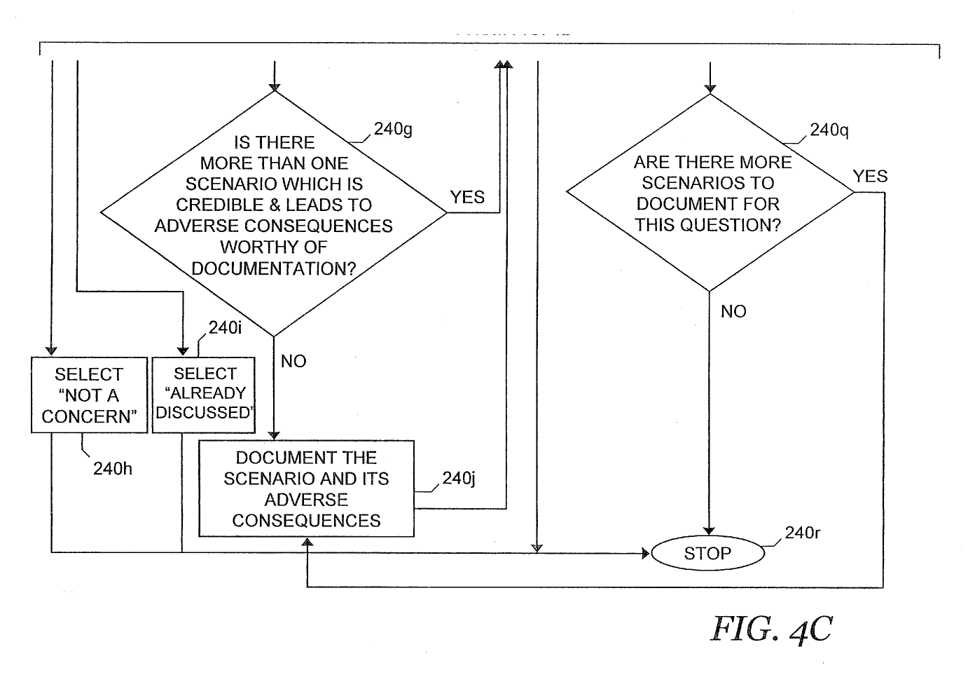

After the process is broken into nodes (block 160), then the user can enter the second component or phase, “Conducting Study” (block 200). A particular node is selected for study (block 210). The user then queries the program (block 220)and discusses specific hazard scenarios (block 230). After various hazard scenarios are discussed, the hazard scenarios are documented (block 240). The documentation of hazard studies is more fully illustrated in FIG. 4 and the description thereof. After the hazard scenarios are documented (block 240), the consequences of the hazards are classified (block 250), and the controls and expected frequency of the hazards identified (block 260). The risk ranking is determined (block 270) and a determination whether the controls are adequate is made (block 280). After the determination, then recommendations may be made as appropriate (block 290), with the user or supervisor of the study optionally assigning persons to carry out the recommendation.

The user may then determine if there are more scenarios to be documented (block 291). If so, then the scenario is subjected to the hazard documentation of block 240, and the blocks and determinations that follow. If there are no more scenarios to be analyzed, then the user can determine if there are more questions to be asked. If yes, then hazard scenarios are discussed (block 230), and the blocks that follow carried out. If there are no more questions, then the user can determine if there are any more nodes upon which a study must be conducted. If there are more nodes to be analyzed, then the user selects the next node (block 210) and carries out the process for conducting the study (block 200) as described herein, for each node to be studied. If no more nodes are needed to be analyzed, then the conducting study component of the invention (block 200) is ended (block 294), and a report is generated (block 295). In the Conducting Study phase (block 200), the risk matrix created or selected in Preplanning Studies (block 100) is applied to the hazard scenarios developed for each node, as defined herein.

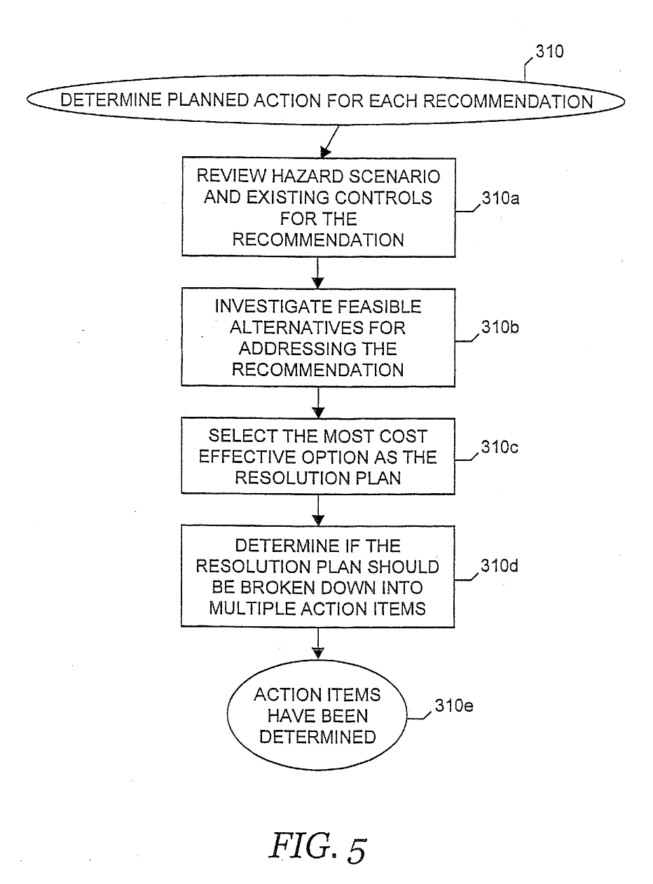

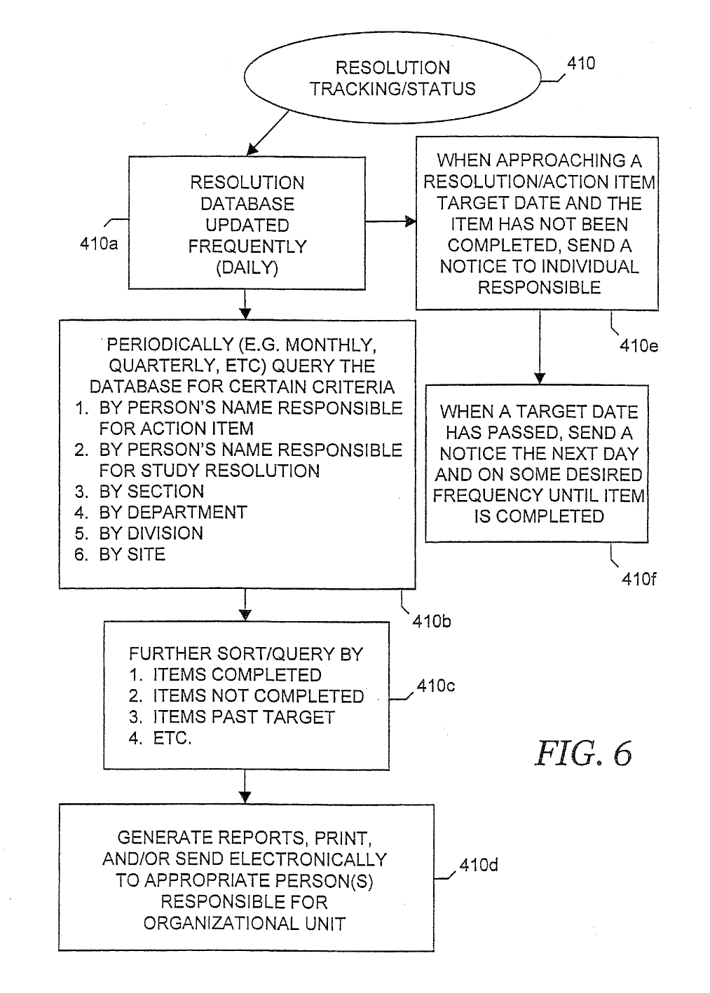

After generating a report about the study, the user may then enter the Resolution Phase (block 300). In this phase, users may use the report generated at block 295 and determine planned resolution(s) and/or action(s) for each recommendation (block 310). This determination is more fully described in FIG. 5 and the description thereof. After the resolution is determined (block 310), then a determination as to who the responsible person(s) to carry out the resolution may be made (block 320), as well as an appropriate schedule or timetable (block 330). The resolution plan may then be documented, and approval from the appropriate authorities or supervisors secured (block 340). As actions are completed, or resolution plans change, these resolutions and actions may be tracked, as illustrated in block 400, and a status report updated (block 350). The tracking and updating of the resolutions determined by the invention is more fully described in FIG. 6 and the description thereof. After all actions are completed, completion reports may be generated (block 360).

Scheduling/tracking study status (including resolution tracking) (block 400) will now be described. As actions and resolutions are completed (block 350), the report of the progress of the resolution data is updated per study, the number of resolutions completed, the number of resolutions that are or are not meeting a determined timetable, and the like (block 410). Additionally, the study status is able to track how the resolution effort for multiple studies is progressing as per division, per department, per person responsible for particular tasks, and the like (block 450).

FIG. 2 illustrates certain processing operations of one embodiment of the invention that allow the user of the present invention to customize the process hazard analysis for specific site use, generally shown in FIG.1 as block 110. Some sites may already have standard PHA protocols that are already in use. For example, the Tennessee Eastman Division (TED) in Kingsport, Tenn. utilizes a study type referred to “TEDPHA.” Using TED as an exemplary site, a user at a different site may first determine whether or not to use TEDPHA, the standard study type, as the default of the particular PHA being performed (block 110a). If the user elects to use the standard study type (block 110b), the user may enter site-specific information for later inclusion in the PHA report. If the user decides (block 110a) not to use the standard study type, then the user can determine if another study type has been developed that meets the needs of the site at which the PHA is being performed (block 110c).

An example of a screen display that a user might see when selecting a particular study type may allow the user to select from official study types (such as TEDPHA) and other study types by selecting associated questions as desired. The user also has the option at this point to add a “What-if Question.” “What-if” methodology is known in the art as a free-form brainstorming technique that can be used to identify potential hazards of a process or node.

Referring again to FIG. 2., if there is no study type that has been developed, then the user may elect to create a study type (block 110f), the process steps of which are more fully described in FIG. 3 and the descriptions thereof. If a study type that meets the site's needs has already been developed, then the user may decide to change the default study type of the PHA system to the selected study type (110d). After making this determination, the user may then enter site specific information for reports as described above. Regardless of which study type is selected, after the site specific information is entered for purposes of the report, the user may examine if the general report verbiage is acceptable for the purposes of the PHA being performed (block 110g). If the general report verbiage is acceptable, the user may then choose whether or not to edit Master Lists based on different site needs, such as control lists, coverage reason, personnel, security privilege, and regulation master (block 110h). If no editing is desired, the customization of the PHA for the site use is complete (block 110k). If editing is desired, then after the user edits the master list (block 110j), the customization of the PHA for the site use is complete (block 110k). If the user decides at the determination point shown as block 110g that the general verbiage report is not acceptable, the user may then edit or create report verbiage that is specific to the site at which the PHA is being performed. After creating or editing the verbiage, the user may then move on to the decision whether or not to edit the Master Lists (block 110h), and then proceed with the determinations that follow as described above.

Screen displays may be provided to a user during the process of customizing a study type or creating a new study type, as provided by embodiments of the present invention. A screen display may be provided that a user may use to choose existing questions/queries from known study types and to associate these questions with a new study type. The screen display may also allow the user to create entirely new questions to be included in a new or edited study type. A screen display also may be provided that a user may use to design or change the screen behavior when a particular question in a study type is asked during the conducting of the study. For example, the user may specify if the question will require the display of controls, and/or a consequence (i.e., a risk matrix value, as described below), and/or a frequency of the consequence (another risk matrix value), and/or the risk priority value, etc. A screen display may also provide a portion of a master control list that a user may edit.

FIG. 3 illustrates certain processing operations of one embodiment of the invention that allow the user of the present invention to create and edit study types and options for specific site use, generally shown in FIG. 1 as block 120. If the user decides to create or edit a new study type, the user may first be asked to name the new study type (block 120a). The user may then select the desired fields to populate for a question for the study type (block 120b), after which the user decides whether or not to use an existing risk matrix (block 120c). If the user does not wish to use an existing risk matrix, the user may then create a new risk matrix (block 120e), after which the new risk matrix is copied into the new study type.

A screen display may be provided that a user of the present invention might view in the process of creating and naming a study type. The user is prompted to enter or select a name for the study type, and may specify the plant site and/or division thereof for which the study type is being created. The user may also define parameters of risk matrices to be used in the study type, screen behavior type, methodology types and questions that may be used to query the node or process during the conducting of the study, the kinds of resolution plan or action items desired, control types, time frames and matrix values that must be kept constant, and types of reports that the user desires to be available with the study type.

A screen display of a blank risk matrix also may be provided that may be configured by the user for a new, customized or edited study type. The risk matrix can be configured to any size, thus providing an advantage over previous methodologies of conducting PHAs, which limited users to particular risk matrices of predetermined sizes and containing predetermined values of risk severity and frequency. An example of how a user or a team of users may design a risk matrix according to the present invention is as follows: For each PHA question, the user will assign one or more consequences. For example, a question may be “what are the potential consequences of the failure of an excess flow valve?” The assigned consequence will generally be based on the flammability, toxicity, reactivity, and quantity of the materials present in the node (i.e., in the particular step or steps in the process, or in the piece of equipment). The Eastman Kingsport, Tennessee Site (EKS) has adopted the following four consequence ratings based on the level of severity of the hazard: Catastrophic event (class D), Serious event (class C), Major event (class B), and Moderate event (class A). Once the user has assigned a consequence rating to the potential hazard, the user will also assign a frequency of occurrence to the hazard. In most cases, the frequency cannot be accurately predicted. Therefore, a subjective approach with some guidelines is employed. Assigning the correct frequency relies heavily upon the user's experience with the process. The following four frequencies are adopted within EKS to characterize the potential hazardous events: Frequent (once/year), Likely (once/10 years), Possible (once/100 years), and Improbable (less than once/100 years).

To assign the frequency, the team must review all the engineering and administrative controls that may mitigate/alleviate the potential hazard in question. The team must consider the frequency of a single failure or realistic simultaneous (common cause) failures of these controls when assigning a frequency of occurrence to the potential incident, some of which may be determinable from known sources (e.g., Frank P. Lees, Loss Prevention in the Process Industries, (Butterworth-Heinmann, London, United Kingdom, 1986, and similar sources). After the user has assigned these values to the potential hazard in question, the user may then enter the these values on the risk matrix. When the study is actually conducted on a chemical process, the values from the risk matrix will be cross-referenced to obtain the risk ranking.

Referring again to FIG. 3, if the user elects to use an existing risk matrix, the matrix is selected and then copied into the new study type (block 120d). After copying the matrix into the study type, the user may determine whether or not checklists and questions are available for the study type (block 120f). If checklists and questions are available for the study type, then the user may determine whether or not existing timelines need to be changed (block 120j). If not, the user may then proceed to determine whether the standard report verbiage needs to be edited (block 120l). If the user determines that timelines need to be changed, then the new time lines and target dates are entered (block 120k), after which the user may then proceed to determine whether the standard report verbiage needs to be edited (block 120l). If the standard report verbiage does not need to be edited, then the phase related to creating or editing study types ends (block 120n). If the standard report verbiage is edited (block 120m), then the phase related to creating or editing study types ends (block 120n) after the editing.

In FIG. 1, block 200 generally illustrates a component related to the actual conducting of the study, of which a part is documenting particular hazard scenarios. FIG. 4 illustrates certain processing operations of one embodiment of the invention that allow the user to document hazard scenarios, generally shown in FIG. 1 as block 240. The processing operations illustrated in FIG. 4 are performed for each question (block 240a). The user first determines if the particular question is applicable to the node upon which the PHA is being performed (block 240b). If not, then the user selects the option “not a concern” (block 240h) and the processing for this particular question ends (block 240r).

If the question is applicable to the node, then the users participating in the study may consider and identify possible hazard scenarios that could lead to adverse consequences (block 240c). Questions that may be asked and determined by the user include whether or not it is credible to reach conditions that could lead to adverse consequences (block 240d); if the consequences have an adverse impact to health, safety, environment, or a significant business interruption (block 240e); if this new scenario(s) has been already discussed and documented (block 240f); and if there is more than one scenario that is credible and leads to adverse consequences worthy of documentation (block 240g).

If a scenario has already been discussed and documented, then inquiry into that scenario may end with the user selecting the option “already discussed” (block 240i). If a scenario is credible and may lead to adverse consequences, the user may elect to document the scenario and its adverse consequences (block 240j). If a scenario is deemed worthy of documentation, then the user may also determine which of the scenario's consequences represent the worst case credible consequence and document it first (block 240k); may prioritize the consequences by selecting from the given choices (block 240l); may list the engineering and administrative controls related to prevent, alleviate, or mitigate the incident (controls that are indirectly applicable to the scenario are generally not listed)(block 240m); and may determine the frequency of reaching the stated consequence (based on the scenario and existing controls)(block 240n).

The user may also determine if the controls are adequate (block 240o). If the controls are deemed to be adequate, then the user may elect to stop the inquiry into the particular scenario (block 240r) and turn to another question (block 240a). If controls are not deemed adequate, the user may then make a conceptual recommendation (more than one if possible), and may assign the recommendation to a team member (block 240p). Finally, the user may determine if there are more scenarios to document for this question (block 240q). If not, then the “document hazards” phase of the PHA ends (block 240r). If additional scenarios are to be documented, then the determinations described herein and illustrated as blocks 240j-240p may be repeated.

Referring again to FIG. 1, block 300 generally illustrates a component related to the resolution phase of the study, of which a part is determining planned resolutions and actions for each recommendation. FIG. 5 illustrates certain processing operations of one embodiment of the invention that allow the user to determine planned resolution and action items, generally shown in FIG. 1 as block 310. Referring to FIG. 5, the user may first review a particular hazard scenario and controls for a recommendation (block 310a). Next, the user investigates feasible alternatives for addressing the recommendation (block 310b). After optionally selecting the most cost effective option as the resolution plan (block 310c), the user next may determine if the resolution plan should be broken down into multiple action items (block 310d). At the conclusion of this process, the action items have been determined (block 310e).

When deciding if the resolution plan for a particular recommendation should have more than one action item, it is preferable that consideration be given to the need to implement interim solutions quickly, especially if the ultimate permanent solution will take a long time to implement (i.e. involves capital or involves a return to lab scale to determine different chemistry, etc.). Also, the nature of the work required to implement the resolution plan may lend itself to multiple actions that may include assignments to more than one person, and/or assignments that may vary in duration, and/or assignments that are sequential in nature. In either case, the use of multiple action items enables, for example, a chemical company to make and show progress towards implementing the resolution plan for the recommendation.

In one exemplary process for determining planned action items for a recommendation, the user may first decide if any interim action item(s) (i.e., action items to be implemented before the final resolution is completed) is needed. In making the decision, the user first determines if the scenario for this recommendation has a risk ranking high enough to indicate that the process should be shut down until corrective action is taken. If so, then generally the process is shut down until corrective action is taken.

Additionally, the user may determine if there is a solution that can be accomplished quickly (i.e., in days) and a “quick fix” can resolve the issue permanently. If so, this solution is documented, and this action/resolution item is implemented. If no “quick fix” is available, the user may then determine if the risk involved may be limited to an acceptable level until a long term fix is accomplished, such that the process may be restarted. If so, then both the interim fix with a short target date and the longer term fix with the appropriate target date are documented. Once the interim fix is accomplished, then the process may be restarted. Progress towards the long term solution is accordingly monitored. Of course, if the user determines that it is not possible to limit the risk involved to an acceptable level until a long term fix is accomplished, the process must remain down until the long term solution is accomplished.

If the user determines that the scenario for a particular recommendation does not have a risk ranking high enough to indicate that the process should be shut down until corrective action is taken, (i.e., is determined to be medium risk), then the user may determine if it Will take a long time (i.e., more than a year) to implement the necessary corrective action. If so, the user may determine an appropriate interim action that may be taken to reduce the risk. The interim action may then be documented and implemented. Furthermore, the long-term permanent solution may also be documented and tracked until completion. If it is determined that the long term (permanent) corrective action will not take a long time to accomplish (i.e., less than a year), only that corrective action may be documented and tracked to closure.

If the user determines that the scenario for a particular recommendation does not have a risk ranking high enough to indicate that the process should be shut down until corrective action is taken, and a determination of low risk is made, then action items may be considered continual improvement opportunities, and may be assigned extended target dates, or no target dates at all.

In another example of a process for determining planned action items for a recommendation, the user may determine if more than one action item is needed, due to the nature of the work needed to implement the recommendation. If not, then only one action item is documented. If so, the user may first determine if there is more than one task associated with the implementation of the recommendation. Additionally, the user may determine if different persons have responsibility for the tasks/action items. The user may also determine if the tasks are sequential in nature or are of varying durations.

Referring again to FIG. 1, block 400 generally illustrates a component related to the scheduling/tracking study status, which component includes tracking of resolution status. FIG. 6 illustrates certain processing operations of one embodiment of the invention that allow the user to track study and resolution status, generally shown in FIG. 1 as block 410. In one embodiment of the invention, a resolution database is generated and maintained, and is updated frequently (i.e., daily, depending on the particular site and the needs thereof) (block 410a). Periodically (e. g,. monthly, quarterly, etc.) the user may query the database for certain criteria or by certain fields, including by a person's name responsible for action item; by a person's name responsible for study resolution; by section, department; division or plant site (block 410b), and the like. The database may be further sorted or queried by items completed; items not completed; items past target, and the like (block 410c). After the database is queried by fields chosen by the user, the user may then generate status reports, print reports, and/or send notices regarding study or resolution tracking electronically to appropriate person(s) responsible for either the tasks themselves or for an organizational unit (block 410d). In one embodiment of the invention, when an resolution/action item target date is approaching and the item has not been completed, a notice is sent to the individual responsible for completing the item (block 410e). In another embodiment of the invention, after a target date has passed, a notice may be sent the next day and additionally at some desired frequency until the item is completed (block 410f).

In a preferable embodiment, the invention facilitates the user in conducting PHAs to meet OSHA requirements. The skilled artisan, however, will recognize that the invention may also be used to conduct other safety analyses or process studies, by, for example, specifying the use of study types of alternative study types.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of conducting a process hazard analysis (PHA), comprising the following steps that are performed in a data processing system:
selecting a chemical process to be evaluated;
selecting a study type to be performed on the chemical process;
conducting the selected study type on the chemical process, wherein the chemical process is evaluated for the presence of a hazard scenario; and then
generating a resolution plan to the hazard scenario.

2. The method of claim 1, wherein the study type is selected from the group consisting of TEDPHA, TEXPHA, Maintenance and Operability (MOP) and Distributed Control System (DCS) study types.

3. The method of claim 1, wherein the PHA is conducted in order to comply with the Process Safety Management (PSM) standard and the Environmental Protection Agency Risk Management Plan.

4. The method of claim 1, wherein the chemical process is evaluated for a Worst Case Credible Consequence hazard scenario.

5. The method of claim 1, wherein the study type is a revalidation study of the chemical process.

6. The method of claim 1, wherein the study type is an initial study of the chemical process.

7. The method of claim 1, further comprising the step of dividing the process into nodes prior to the conducting step.

8. The method of claim 1, wherein the conducting step comprises the generation of a risk ranking of the hazard scenario.

9. The method of claim 8, wherein the generation of a risk ranking comprises the analysis of a risk matrix.

10. The method of claim 1, further comprising the step of customizing the study type prior to the conducting step.

11-24. (canceled)

25. A data processing system for conducting a process hazard analysis, comprising:
means for selecting a chemical process to be evaluated;
means for selecting a study type to be performed on the chemical process;
means for conducting the selected study type on the chemical process, wherein the chemical process is evaluated for the presence of a hazard scenario; and
means for generating a resolution plan to the hazard scenario.

26. The system of claim 25, wherein the selecting means comprises means for selecting the study type from the group consisting of TEDPHA, TEXPHA, Maintenance and Operability (MOP) and Distributed Control System (DCS) study types.

27. The system of claim 25, wherein the conducting means comprises means for evaluating the chemical process for a Worst Case Credible Consequence hazard scenario.

28. The system of claim 25, wherein the selecting means comprises means for selecting a revalidation study of the chemical process.

29. The system of claim 25, wherein the selecting means comprises means for selecting an initial study of the chemical process.

30-46. (canceled)

47. A computer program product for conducting a process hazard analysis, the computer program product comprising a computer-readable storage medium having computer-readable program code embodied in the medium, the computer-readable program code comprising:
computer-readable program code for selecting a chemical process to be evaluated;
computer-readable program code for selecting a study type to be performed on the chemical process;
computer-readable program code for conducting the selected study type on the chemical process, wherein the chemical process is evaluated for the presence of a hazard scenario; and
computer-readable program code for generating a resolution plan to the hazard scenario.

48. The computer program product of claim 47, wherein the computer-readable program code for selecting the study type comprises computer-readable program code for selecting the study type from the group consisting of TEDPHA, TEXPHA, Maintenance and Operability (MOP) and Distributed Control Computer program product (DCS) study types.

49. The computer program product of claim 47, wherein the computer-readable program code for conducting the study type comprises computer-readable program code for evaluating the chemical process for a Worst Case Credible Consequence hazard scenario.

50. The computer program product of claim 47, wherein the computer-readable program code for selecting the study type comprises computer-readable program code for selecting a revalidation study of the chemical process.

51. The computer program product of claim 47, wherein the computer-readable program code for selecting the study type comprises computer-readable program code for selecting an initial study of the chemical process.

52-68. (canceled)
